(19) United States
(12) Patent Application Publication
(10) Pub. No.: US 2013/0043620 A1
(43) Pub. Date: Feb. 21, 2013

(54) CYLINDRICAL CORE MEMBER AND METHOD OF MANUFACTURING TUBULAR MEMBER

(71) Applicant: Futoshi TAKEI, Kanagawa (JP)

(72) Inventor: Futoshi TAKEI, Kanagawa (JP)

(73) Assignee: FUJI XEROX CO., LTD., TOKYO (JP)

(21) Appl. No.: 13/354,913

(22) Filed: Jan. 20, 2012

(30) Foreign Application Priority Data
Aug. 19, 2011 (JP) 2011-179433

(51) Int. Cl. B29C 41/00; B28B 7/28; B29C 41/42

(52) U.S. Cl. 264/331.19; 264/331.11; 249/175

(57) ABSTRACT

A cylindrical core member for manufacturing a tubular member by curing a resin solution coated on an outer circumferential surface thereof, includes a substrate, a releasing layer that is formed on the outer circumferential surface including a central portion of the substrate in the axial direction, and plural low releasing portions having lower releasing properties than the releasing layer at both end portions of the substrate in the axial direction, the plural low releasing portions being intermittently disposed on the outer circumferential surface in the circumferential direction, and present in some places in the axial direction of the core member main body at the circumferential of the core member main body at both end portions of the substrate in the axial direction.

### CROSS-REFERENCE TO RELATED APPLICATIONS

This application is based on and claims priority under 35 USC 119 from Japanese Patent Application No. 2011-179433 filed Aug. 19, 2011.

### BACKGROUND

1. Technical Field

The present invention relates to a cylindrical core member and a method of manufacturing a tubular member.

2. Summary

According to an aspect of the invention, there is provided a cylindrical core member for manufacturing a tubular member by curing a resin solution coated on an outer circumferential surface thereof, including: a substrate; a releasing layer that is formed on the outer circumferential surface including a central portion of the substrate in the axial direction; and plural low releasing portions having lower releasing properties than the releasing layer at both end portions of the substrate in the axial direction, the plural low releasing portions being intermittently disposed on the outer circumferential surface in the circumferential direction, and present in some places in the axial direction of the core member main body at the circumferential of the core member main body at both end portions of the substrate in the axial direction.

### BRIEF DESCRIPTION OF THE DRAWINGS

Exemplary embodiments of the present invention will be described in detail based on the following figures, wherein:

FIG. 1 is an explanatory view for explaining an example of a spiral coating method;

FIG. 2 is an explanatory view for explaining an example of a spiral coating method;

FIG. 3 is a schematic view showing an example of the configuration of the core member;

FIG. 4 is an explanatory view for explaining an example of the heating process; and

FIG. 5 is an explanatory view for explaining an example of the releasing process.

### DETAILED DESCRIPTION

Hereinafter, an example of an exemplary embodiment of the invention will be described based on the drawings. Meanwhile, the drawings only show members that are necessary for the description for easy understanding. In addition, members having the same function will be given the same reference number throughout the entire drawings, and will sometimes not be described. While the present exemplary embodiment describes an example of a method of manufacturing an intermediate transfer belt as an example of a tubular member, the manufacturing method according to the exemplary embodiment may be applied to manufacturing of a fixing belt, a paper transport belt, and other tubular members.

<Coating Process>

The method of manufacturing an intermediate transfer belt of the exemplary embodiment has a coating process in which the axis of a core member is horizontal, and the core member is rotated about the axis, and a resin solution is coated on the outer circumferential surface of the rotating core member, thereby forming a coated film.

Examples of the resin that is used to compose the intermediate transfer belt include polyimide resins (hereinafter sometimes referred to as PI) or polyamide-imide resins (hereinafter sometimes referred to as PAI) in terms of strength, dimension stability, heat resistance, and the like, but are not limited thereto. A variety of well-known resins may be used as the PI or PAI, and, in the case of the PT, precursors thereof may be coated as well.

A PI precursor solution, which is a resin solution, is obtained by, for example, causing a reaction of a tetracarboxylic dianhydride and a diamine component in a solvent. The kinds of the components are not particularly limited, but a solution obtained by causing a reaction of an aromatic tetracarboxylic dianhydride and an aromatic diamine component is preferable from the standpoint of film strength.

Typical examples of the aromatic tetracarboxylic acid include pyromellitic dianhydrides, 3,3′,4,4′-biphenyl tetracarboxylic dianhydride, 3,3′,4,4′-benzophenone tetracarboxylic dianhydride, 2,3,4,4′-biphenyl tetracarboxylic dianhydride, 2,3,6,7-naphthalene tetracarboxylic dianhydride, 1,2,5,6-naphthalene tetracarboxylic dianhydride, 2,2-bis(3,4-dicarboxyphenyl)ether dianhydride, tetracarboxylic esters thereof, mixtures of the above tetracarboxylic acids, and the like.

Meanwhile, the aromatic diamine component includes paraphenylene diamine, metaphenylene diamine, 4,4′-diaminodiphenyl ether, 4,4′-diaminophenylmethane, benzidine, 3,3′-dimethoxybenzidine, 4,4′-diaminodiphenyl propane, 2,2-bis[4-(4-aminophenoxy)phenyl]propane, and the like.

Meanwhile, the PAI is obtained by combining an acid anhydride, for example, trimellitic anhydride, ethylene glycol bis-anhydro trimellitate, propylene glycol bis-anhydro trimellitate, pyromellitic anhydride, benzophenone tetracarboxylic anhydride, 3,3′,4,4′-biphenyl tetracarboxylic anhydride, or the like, and the diamine, and causing a polycondensation reaction in the equivalent molar quantities. Since the PAI has an amide group, and is thus easily dissolved in a solvent even when an imidization reaction proceeds, a 100%-imidized PAI is preferable.

Examples of the solvent that is included in the resin solution and may be used include non-proton-based polar solvents, for example, N-methylpyrrolidone, N,N-dimethyl acetamide, acetamide, or the like. The concentration, viscosity, and the like of the solution are not limited, but the solid content concentration of the solution is desirably 10% by mass to 40% by mass, and the viscosity is desirably 1 Pa·s to 100 Pa·s in the exemplary embodiment.

Conductive particles may be added to the resin solution according to necessity. Examples of the conductive particles that are dispersed in the resin solution include carbon-based substances, such as carbon black, carbon fibers, carbon nanotubes, and graphite, metals or alloys, such as copper, silver, and aluminum, conductive metallic oxides, such as tin oxide, indium oxide, and antimony oxide, whiskers, such as potassium titanate, and the like. Among the above, carbon black is particularly preferable from the viewpoint of the dispersion stability in a liquid, the properties of exhibiting the semiconducting properties, the price, and the like.

As the method of dispersing the conductive particles, well-known methods, such as ball milling, sand milling (beads milling), or jet milling (opposed impact-type disperser) may be employed. A surfactant, a leveling agent, or the like may be added as a dispersion aid. The dispersion concentration of the conductive particles is 10 parts (referring to as parts by mass here and below) to 40 parts, and particularly preferably 15 parts to 35 parts with respect to 100 parts of the resin component.

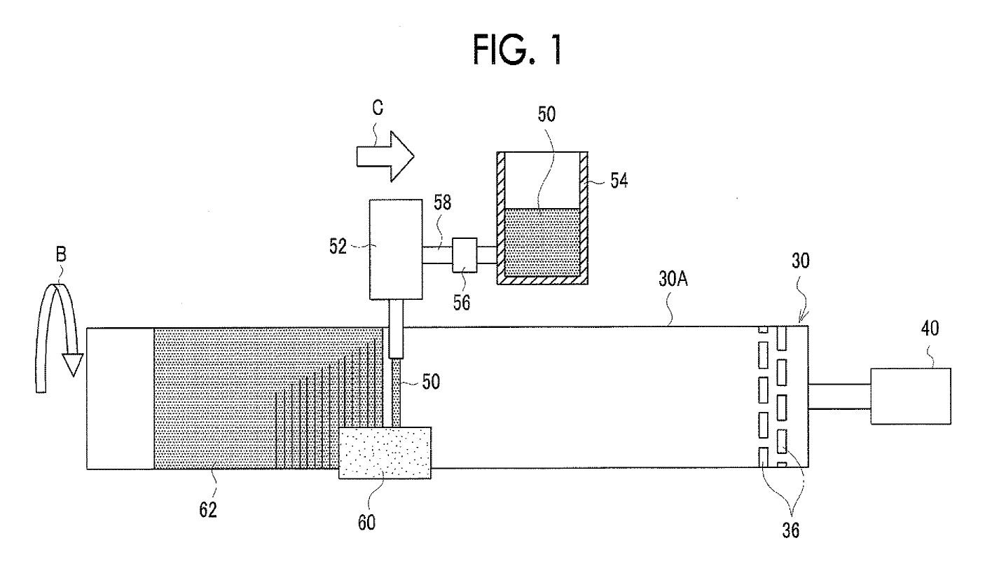

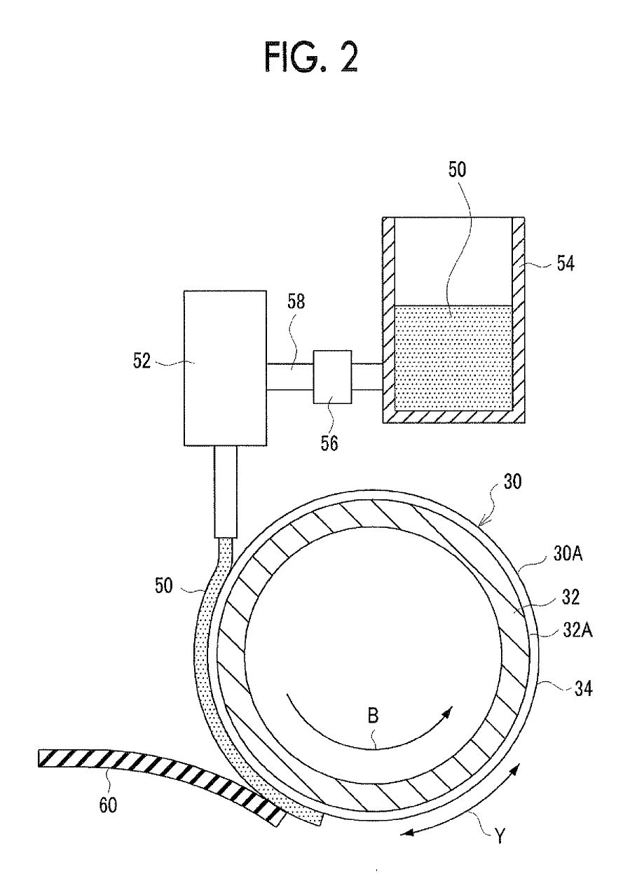

In the exemplary embodiment, the method of coating the resin solution is not particularly limited; however, for example, a spiral coating method is used. FIGS. 1 and 2 are explanatory views of a spiral coating method.

As shown in FIGS. 1 and 2, in the spiral coating method, the axis of a cylindrical core member 30 is horizontal, the core member is rotated around the axis (in the arrow B direction) by a rotating apparatus 40, a resin solution 50 is poured from a pouring apparatus 52, and adhered to the outer circumferential surface 30A of the core member 30. The resin solution 50 is supplied to the pouring apparatus 52 from a tank 54 that retains the resin solution 50 by a pump 56 through a supply pipe 58. The resin solution 50 adhered to the outer circumferential surface 30A of the core member 30 is flattened by a spatula 60. Meanwhile, the specific configuration of the core member 30 will be described below.

The pouring apparatus 52 and the spatula 60 are supported so as to be movable in the axial direction (the arrow C direction) of the core member 30. The pouring apparatus 52 and the spatula 60 move in the axial direction (the arrow C direction) of the core member 30, and eject the resin solution 50 in a state in which the core member 30 is rotated at a preset rotation rate, thereby coating the resin solution 50 in a spiral shape on the surface of the core member 30. The coated resin solution is flattened by the spatula 60, and the spiral line is erased, thereby forming a seamless coated film 62. The film thickness is set in a range of, for example, 50 μm to 150 μm according to necessity in a completed state.

(Configuration of the Core Member)

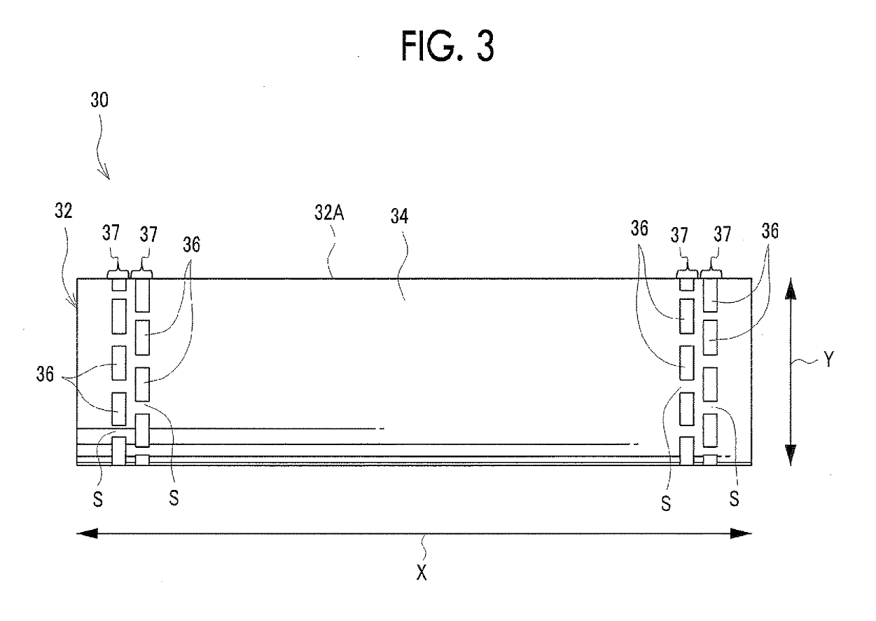

As shown in FIGS. 2 and 3, the core member 30 according to the exemplary embodiment has a cylindrical core member main body 32 with which a resin solution coated on the outer circumferential surface 32A (outer circumferential surface 30A) is cured by heating so as to manufacture a tubular member, a releasing layer 34 that is formed on the outer circumferential surface 32A including the central portion of the core member main body 32 in the axial direction, and plural low releasing portions 36 that are intermittently formed on the outer circumferential surface 32A in the circumferential direction at both end portions of the core member main body 32 in the axial direction, and have lower releasing properties which are more than the releasing layer 34. Meanwhile, the circumferential direction of the core member main body 32 (core member 30) is indicated by the arrow Y in FIGS. 2 and 3, and the axial direction of the core member main body 32 (core member 30) is indicated by the arrow X in FIG. 3.

The low releasing portions 36 are present in some places in the axial direction of the core member main body 32 across the circumferential direction of the core member main body 32 at both end portions of the core member main body 32 in the axial direction.

Specifically, the low releasing portions 36 are configured as follows. That is, each of the low releasing portions 36 is formed in a rectangular shape having a long side in the circumferential direction of the core member main body 32. The low releasing portions 36 are intermittently disposed in the circumferential direction of the core member main body 32 so as to configure lines 37. In detail, the plural low releasing portions 36 are disposed in the circumferential direction of the core member main body 32 at constant intervals in the lines 37.

In the exemplary embodiment, two lines 37 of the low releasing portions 36 are provided at both portions and the other end portion of the core member main body 32 in the axial direction. Gaps S are formed between the low releasing portions 36 that are adjacent to each other in the circumferential direction of the core member main body 32 in each of the lines 37. The lengths of the plural gaps S in the circumferential direction are same, and the length of the gap S in the circumferential direction is shorter than the length of the low releasing portion 36 in the circumferential direction. The low releasing portions 36 in one of the two lines 37 are present at sites in the axial direction of the gaps S in the other of the two lines 37.

Meanwhile, as long as the low releasing portions 36 are present in some places in the axial direction of the core member main body 32 across the circumferential direction of the core member main body 32 at both end portions of the core member main body 32 in the axial direction, other configurations may be employed. For example, the shape of the low releasing portion 36 is not limited to the rectangular shape, and may be another quadrilateral shape or the like. In addition, the low releasing portions 36 are not limited to the configuration in which the low releasing portions are disposed at constant intervals in the circumferential direction of the core member main body 32, and may be disposed at different intervals in the circumferential direction of the core member main body 32. In addition, three or more lines 37 may be provided at both portions and the other end portion of the core member main body 32 in the axial direction.

Examples of the material for the core member main body 32 which is used in the exemplary embodiment include aluminum, stainless steel, and other metals. The width (length in the axial direction) of the core member main body 32 (core member 30) needs to be equal to or larger than the width (length in the axial direction) of a target tubular member, but is desirably approximately 10% to 40% larger than the width of a target intermediate transfer belt in order to secure allowance areas for ineffective areas that are generated at the end portions. The circumferential length (length in the circumferential direction) of the core member main body 32 (core member 30) is, for example, the same as or slightly larger than the length of a target intermediate transfer belt. Meanwhile, the low releasing portions 36 are provided in the ineffective areas.

The thickness of the cylindrical core member main body 32 (core member 30) is preferably approximately 0.5 mm to 10 mm. A smaller thickness makes welding difficult, and a larger thickness makes it difficult to roll the core member main body into a cylindrical shape. The core member main body 32 (core member 30) is obtained by, for example, cutting a quadrilateral metal sheet material to a predetermined width and length, rolling the sheet material, and joining both end portions of the sheet material through welding.

The releasing layer 34 is configured by, for example, coating a material selected from inorganic compounds, silicon-based resins, and fluorine-based resins on the outer circumferential surface 32A of the core member main body 32. The coating of the material on the outer circumferential surface 32A of the core member main body 32 is carried out by, for example, coating a mold release agent made of the above material on the outer circumferential surface 32A of the core member main body 32, and then heating and burning the core member main body 32. In addition, the releasing layer 34 may be configured through, for example, a plating treatment of chromium, nickel, or the like on the outer circumferential surface 32A of the core member main body 32.

The low releasing portion 36 is configured to have lower releasing properties than the releasing layer 34 through, for example, reforming, such as a UV treatment. In addition, the low releasing portion 36 may be formed by partially removing the releasing layer 34 through a polishing treatment or the like. In addition, the core member main body 32 may be partially masked in advance, and a mold release agent made of the above material is coated on the core member main body 32 so as to form the releasing layer 34, whereby the masked portions may be configured as the low releasing portions 36.

<Drying Process>

The method of manufacturing an intermediate transfer belt of the exemplary embodiment has a drying process in which the coated film is dried. Meanwhile, the “drying” refers to heating for vaporizing a predetermined amount or more of the solvent included in the thermosetting solution that composes the coated film 62.

Specifically, it is preferable to heat and dry the solvent while the core member 30 is rotated using the above rotating apparatus 40. The heating is preferably carried out at a temperature of 80° C. to 200° C. for 10 minutes to 60 minutes, and a higher temperature is more preferable since the heating time and the drying time are shortened. It is also an effective heating to strike the solution with hot air. During the heating, the temperature may be increased in a stepwise fashion or at a certain rate. During the heating, the core member 30 may be slowly rotated at approximately 5 rpm to 60 rpm in order to suppress sagging of the coated film.

<Heating Process>

The method of manufacturing an intermediate transfer belt of the exemplary embodiment has a heating process as an example of a curing process in which the dried coated film is cured by heating.

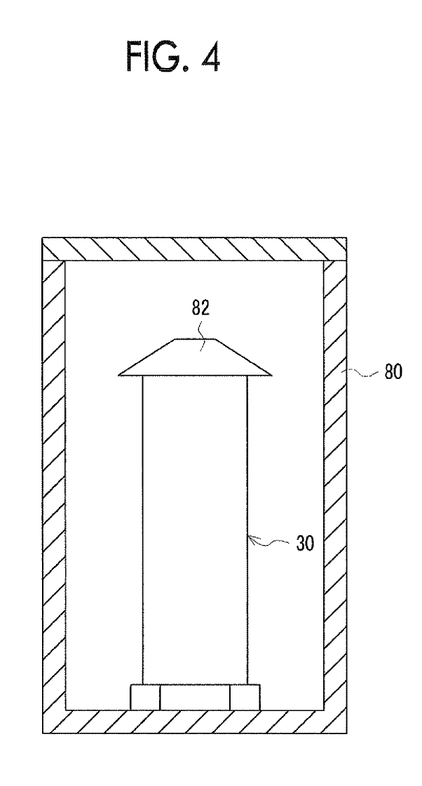

The heating process becomes necessary when a material that causes a curing reaction by heating, such as a PI precursor solution, is used in the resin solution. As shown in FIG. 4, in the heating process, the core member is fed and heated in a heating oven 80. The heating temperature is preferably approximately 250° C. to 450° C., and more preferably 300° C. to 350° C. Heating of the coated film of the PI precursor solution for 20 minutes to 60 minutes causes an imidization reaction, and a PI resin film is formed. During the heating reaction, it is preferable to carryout the heating by gradually increasing the temperature in a stepwise fashion or at a certain rate before the final temperature of the heating is reached.

Meanwhile, in a case in which the resin solution is a PAI solution, the solution is cured by the drying process in which the solvent is dried so that a film is formed. Therefore, the manufacturing method may not have the heating process.

Meanwhile, since the roll provided in the rotating apparatus is not heat-resistant it is preferable to drop and feed the core member from the rotating apparatus to the heating oven 80 at such a high temperature in the heating process. Generally, the core member is fed into the heating oven 80 in a state in which the axial direction of the core member coincides with the direction in which the gravity acts, that is, the core member stands vertically. The heating oven 80 preferably has a configuration in which hot air is blown out from the top of the core member that stands vertically in order to remove temperature variation as much as possible in the heating oven. In addition, in order to prevent hot air from directly striking on the top portion of the core member, as shown in FIG. 4, a shielding member 82 that shields air may be installed at the top portion of the core member. The shape of the shielding member 82 is not particularly limited as long as the shielding member may cover one end of the core member.

<Releasing Process>

The method of manufacturing an intermediate transfer belt of the exemplary embodiment has a releasing process in which the film formed in the heating process (cured and coated film) is released from the core member.

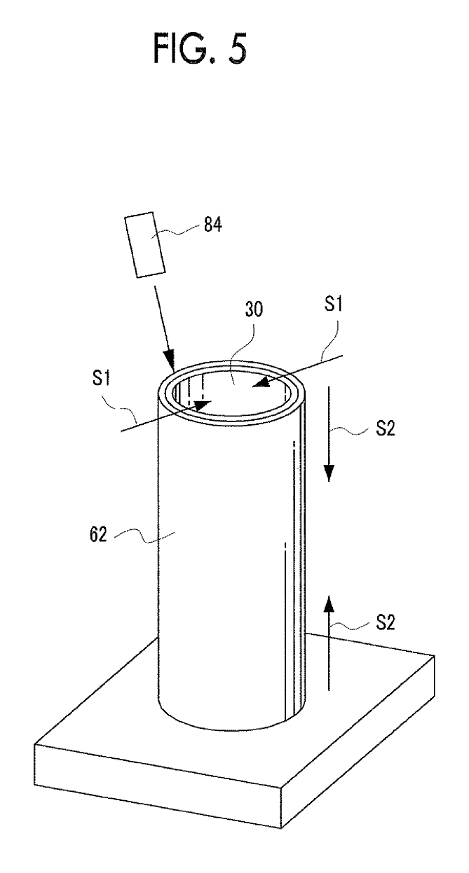

In the releasing process, for example, after completion of the heating process, the core member 30 is taken out from the heating oven 80, and cooled at room temperature, then, as shown in FIG. 5, air is injected into a gap between the film 62 and the end portion of the core member 30 on the outer circumferential surface 30A in the axial direction by an air injection unit 84 so that the film 62 is separated from the core member. Thereby, an intermediate transfer belt is obtained. Since there are defects, such as wrinkles or uneven film thickness, at the end portion of the obtained film, unnecessary portions are cut so as to complete the intermediate transfer belt. There are cases in which a drilling process, a lib-attaching process, or the like is carried out on the intermediate transfer belt according to necessity.

The intermediate transfer belt obtained by the exemplary embodiment is a transferring member that receives images from a photoreceptor or the like and transfers the images to a recording medium, and is used in image-forming apparatuses, such as electrophotographic copiers and laser printers.

(Actions of the Exemplary Embodiment)

In the exemplary embodiment, since the releasing layer 34 is formed in the core member main body 32, the film (cured coated film) 62 and the core member 30 are easily divided, and the coated film 62 is easily separated from the core member 30.

In addition, in the exemplary embodiment, the solvent in the resin solution 50 is vaporized by the drying process and the heating process so that shrinkage of the coated film 62 occurs. In the shrinkage of the cylindrical coated film 62, the inward shrinkage in the radial direction (refer to the arrow S1 in FIG. 5) is restricted by the core member 30. The inward shrinkage in the axial direction (refer to the arrow S2 in FIG. 5) is suppressed by the coated film 62 attached to the low releasing portions 36 or the low releasing portions 36 that supply a resistance to moving of the film inward in the axial direction.

In the exemplary embodiment, since the low releasing portions 36 are present in some places in the axial direction of the core member main body 32 across the circumferential direction of the core member main body 32 at both portions and the other end portion of the core member main body 32 in the axial direction, the inward shrinkage in the axial direction is suppressed across the circumferential direction of the core member main body 32.

In addition, in the exemplary embodiment, vapor of the solvent in the resin solution 50, vapor of water generated by the heating reaction of the resin solution 50, and the like are discharged from the coated film 62 through the gap with the core member 30 in the drying process and the heating process, but the gas and vapor are exhausted from both ends of the core member 30 in the axial direction through the gaps S formed between the low releasing portions 36. Therefore, swelling of the coated film 62 in a lantern shape is suppressed.

The invention is not limited to the exemplary embodiment, and a variety of modifications, changes, and improvements are permitted. For example, the modified example as described above may be appropriately configured by combining plural exemplary embodiments.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cylindrical core member for manufacturing a tubular member by curing a resin solution coated on an outer circumferential surface thereof, comprising:
a substrate;
a releasing layer that is formed on the outer circumferential surface including a central portion of the substrate in the axial direction; and
a plurality of low releasing portions having lower releasing properties than the releasing layer at both end portions of the substrate in the axial direction, the plurality of low releasing portions being intermittently disposed on the outer circumferential surface in the circumferential direction, and present in some places in the axial direction of the core member main body at the circumferential of the core member main body at both end portions of the substrate in the axial direction.

2. The cylindrical core member according to claim 1, wherein the releasing layer contains a material selected from inorganic compounds, silicon-based resins, and fluorine-based resins.

3. The cylindrical core member according to claim 1, wherein the substrate is selected from aluminum or stainless steel.

4. The cylindrical core member according to claim 1, wherein the low releasing portions are formed by a UV treatment or a polishing treatment.

5. The cylindrical core member according to claim 1, wherein the plurality of the low releasing portions are intermittently disposed on the outer circumferential surface in the circumferential direction at both end portions of the substrate in the axial direction, the plurality of the low releasing portions are disposed in a plurality of lines crossing the axial direction, and the low releasing portions are disposed in a zigzag shape.

6. A cylindrical core member for manufacturing a tubular member by curing a resin solution coated on an outer circumferential surface thereof, comprising:
a substrate;
a releasing layer that is formed on the outer circumferential surface including a central portion of the substrate in the axial direction; and
a plurality of low releasing portions having lower releasing properties than the releasing layer at both end portions of the substrate in the axial direction, and
the plurality of low releasing portions are intermittently disposed on the outer circumferential surface in the circumferential direction, the plurality of low releasing portions are disposed in a plurality of lines crossing the axial direction, and the low releasing portions are disposed in a zigzag shape.

7. The cylindrical core member according to claim 6, wherein the plurality of the low releasing portions are disposed in two lines crossing the axial direction.

8. A method of manufacturing a tubular member comprising:
coating a resin solution on an outer circumferential surface of the core member according to claim 1 while the axis of the core member is horizontal and the core member is rotated about the axis, thereby forming a coated film;
curing the coated film by heating; and
releasing a cured coated film in the curing of the coated film from the core member.

9. The method of manufacturing a tubular member according to claim 8, wherein the cured coated film is a resin selected from polyimide and polyamide-imide.

10. The method of manufacturing a tubular member according to claim 8,
wherein the viscosity of the resin solution is 1 Pa·s to 100 Pa·s.

11. The method of manufacturing a tubular member according to claim 8,
wherein the resin solution is a precursor solution of a resin.

12. The method of manufacturing a tubular member according to claim 8,
wherein the coating of the coated film is a spiral coating method.

13. The method of manufacturing a tubular member according to claim 8,
wherein the average film thickness of the cured coated film is in a range of 50 μm to 150 μm.

14. The method of manufacturing a tubular member according to claim 8,
wherein the solid content concentration of the resin solution is 40% by mass or less.

15. A cylindrical core member for manufacturing a tubular member by curing a resin solution coated on an outer circumferential surface thereof, comprising:
a substrate;
a releasing layer that is formed on the outer circumferential surface including a central portion of the substrate in the axial direction; and
a plurality of low releasing portions having lower releasing properties than the releasing layer at both end portions of the substrate in the axial direction,
wherein the plurality of low releasing portions are intermittently disposed on the outer circumferential surface in the circumferential direction, and
the plurality of low releasing portions are disposed that a direction of central of gap formed between the low releasing portions cross the axial direction on the circumferential surface.
